(19) United States
(12) Patent Application Publication
(10) Pub. No.: US 2002/0156658 A1
(43) Pub. Date: Oct. 24, 2002

(54) Risk insurance financial product and method

(76) Inventors: Steven R. Selesny, West Hempstead, NY (US); David N. Fields, New York, NY (US)

Correspondence Address: PROSKAUER ROSE LLP, PATENT DEPARTMENT, 1585 BROADWAY, NEW YORK, NY, 10036, US

(21) Appl. No.: 10/076,205

(22) Filed: Feb. 14, 2002

Related U.S. Application Data
(60) Provisional application No. 60/268,904, filed on Feb. 14, 2001.

(51) Int. Cl. G06F 17/60

(52) U.S. Cl. 705/4

(57) ABSTRACT

An insurance product and insurance method for providing financial assurance, against an occurrence of at least one specified event, are described. In one embodiment, an insurer provides an insurance policy having a risk limit, in exchange for a predetermined first premium from the insured entity, where the risk limit is the maximum monetary risk. The insurer then transfers a variable portion of the risk limit to a reinsurer in exchange for a predetermined second premium. Note that the reinsurer is preferably a captive of the insured. As a feature of the invention, the variable portion of the risk limit decreases over time, and equals a predetermined retainment point less a variable attachment point. For example, the retainment point is a monetary amount less than the risk limit, and the variable attachment point varies over time based on a predetermined investment growth. In a further embodiment, the reinsurer transfers its risk to a third party reinsurer for a premium, where the third party reinsurer acts as a pool administrator for an insurance pool.

### RELATED APPLICATION

This application is based upon provisional application Ser. No. 60/268,904, entitled “FINITE RISK INSURANCE,” filed on Feb. 14, 2001 for Steven R. Selesny and David N. Fields. The contents of this provisional application are fully incorporated herein by reference.

### FIELD OF THE INVENTION

The present invention relates to a unique insurance product and process for providing insurance to companies which face “hard to insure” exposures. For example, the present invention is applicable for technology specific exposures such as network and Internet security (e.g. business interruption, cyber extortion, etc.), technology obsolescence, patent infringement, and copyright infringement.

### BACKGROUND OF THE INVENTION

Risk financing, i.e., risk funding, is the process of establishing the most cost-effective procedures to ensure that finds will be available after a loss to meet post-loss goals. A risk financing plan should consider whether all potential losses have been identified and measured.

Although all major companies deal with certain risk exposures, high tech companies face technology specific risks that are unique to the computer/Internet technology industry. These risks include intellectual property infringement such as copyright or patent infringement, as well as risks related to technology obsolescence, or network and Internet security.

Traditional insurance sources are unlikely to have the data or historical underwriting resources to properly evaluate and insure such risks.

Accordingly, it is an objective of the invention to provide an insurance product and process to insure hard-to-insure exposures.

It is a further object of the invention to provide an insurance product and process to insure against unpredictable risk exposures relating to the risks of the technology industry.

It is another object of the invention to transfer a portion of the risk from the primary insurer to a first reinsurer, where the reinsurer may be a captive of the insured company.

It is an addition object of the invention to transfer the portion of the risk from the first reinsurer to a third-party reinsurer, where the third party reinsurer may be a pool administrator of an insurance pool.

Various other objects, advantages and features of the present invention will become readily apparent from the ensuing detailed description and the novel features which will be particularly pointed out in the appended claims.

### SUMMARY OF THE INVENTION

In an illustrative embodiment of the invention, an insurance product and method provides financial assurance, against an occurrence of at least one specified event, to an insured entity. In particular, an insurer provides an insurance policy having a risk limit, in exchange for a predetermined first premium from the insured entity, where the risk limit is the maximum monetary risk. The insurer then transfers a variable portion of the risk limit to a reinsurer in exchange for a predetermined second premium. Optionally, the reinsurer is a captive of the insured. As a feature of the invention, the variable portion of the risk limit decreases over time, and equals a predetermined retainment point less a variable attachment point. For example, the retainment point is a monetary amount less than the risk limit, and the variable attachment point varies over time based on a predetermined investment growth.

In another embodiment, the variable portion of the risk limit is transferred from the first reinsurer to a second third-party reinsurer in exchange for a predetermined third premium. As an aspect of this embodiment, at least one additional third-party reinsurer (preferably a captive) transfers a portion of a respective risk limit from an insurance policy that it is holding on behalf of its respective insured entity, in exchange for each predetermined respective fourth premium. In this manner, the second reinsurer pools each received portion of said risk limit, from the first reinsurer and each of the at least one third reinsurer, to provide risk sharing.

In another embodiment, a data processing system processes an insurance policy, having a risk limit for providing financial assurance, against an occurrence of at least one specified event. In particular, the data processing system includes a processor for determining a projected loss amount probability, and for determining a first premium, a retainment point, and a variable attachment point based on at least the risk limit and the projected loss amount probability.

### BRIEF DESCRIPTION OF THE DRAWINGS

The following detailed description, given by way of example and not intended to limit the present invention solely thereto, will best be understood in conjunction with the accompanying drawings in which:

FIG. 1 schematically illustrates a set of transactions which implement an insurance product in accordance with an illustrative embodiment of the invention;

FIG. 2 is a graph which shows certain monetary values as a function of time, in accordance with the illustrative embodiment of the invention shown in FIG. 1; and

FIG. 3 schematically illustrates a computer system for processing the insurance product, in accordance with the illustrative embodiment of the invention.

### DETAILED DESCRIPTION OF THE INVENTION

The present invention relates to insuring corporate entities against occurrences of certain losses. Illustratively, such insurance is directed to entities dealing with technology specific risks that may be unique, e.g., to the computer/Interet technology industry. However, the inventive system and process is also applicable to non-high tech entities that deal with other unpredictable risks. For example, the invention is applicable to the pharmaceutical industry that deals with unpredictable risks, such as product liability and product recall losses.

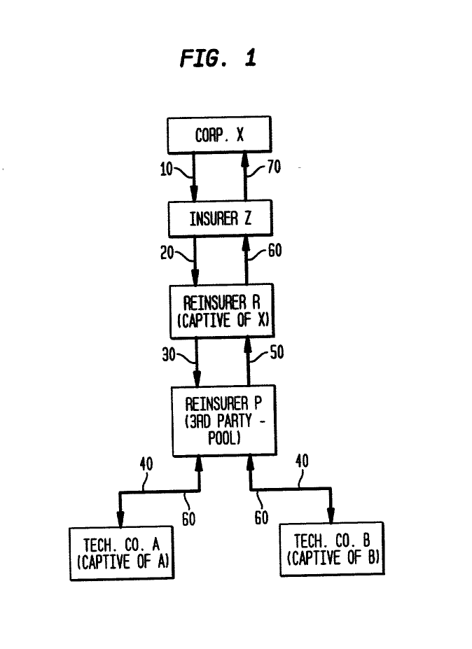

FIG. 1 schematically illustrates a set of transactions which implement an insurance product in accordance with an illustrative embodiment of the invention.

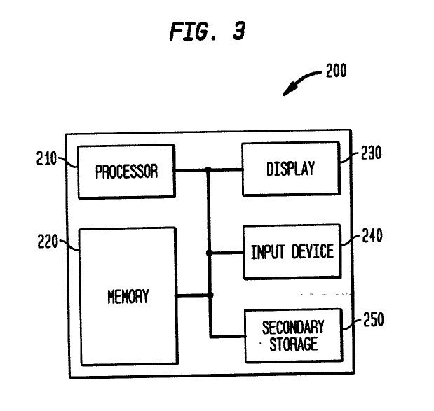

More particularly, Corporation X wishes to obtain insurance for certain risks it may experience, such as intellectual property infringement, technology obsolescence, and network security risks. Corporation X and Insurance Company (Insurer) Z contact each other and Insurer Z typically determines the total amount of coverage, the amount of coverage per occurrence and/or per year (or other time frame), and the premium paid by Corporation X. Note that the premium may be determined via a computer system 200, as shown in FIG. 3, based on several factors, including, but not limited to, the risk limit, the type of insured events, and a projected loss probability (i.e., on actuarially projected losses).

A risk insurance policy, in accordance with the invention, may illustratively include terms such as the effective date, the coverage, the premium, the program limits, a lost reimbursement and claims handling provision, and additional terms.

For example, the “Effective Date” provision may state, “Date/Month/Year, or the date of the premium payment, whichever is later. This indication is valid until 5:00 p.m. EST Date/Month/Year.” The “Coverage” provision may state, “Claims made coverage for occurrences reported subsequent to the Effective Date and prior to the Termination Date noted above for external losses and loss adjustment expenses, including defense costs, related to claims against the Insured for Technology Specific Risks. Such claims must relate to actual settlements made between Insured (X) and another party, regardless of whether the settlement is negotiated or court ordered.” The “Premium” provision may state, “$51,000,000, payable on or before the Effective Date. The Premium includes premium taxes.” The “program limits” provision may state, “$25,000,000 limit per occurrence, $50,000,000 annual limit and $100,000,000 aggregate program limit for covered losses in excess of a retention of $2,500,000 for any one claim and in the annual aggregate, in excess of a retention of $25,000,000 for each and every claim and subject to a program sublimit of $15,000,000. Coverage C losses also have a per occurrence sublimit of $7,500,000.” The “Lost Reimbursement and Claims Handling” provision may include “claims control and cooperation” and “settlement of losses” clauses. Lastly, the “Additional Terms” provision may state, “(1) This indication is exclusive of administration and claims handling services. (2) Subject to securing appropriate reinsurance.”

Referring the FIG. 1, Corporation X transfers the determined premium to insurance company Z, in Step 10. Let us assume that for a risk limit of $100 million to protect against the occurrence(s) of specified events, such as one or more of the technology specific exposures described above, the premium paid is $51 million. Illustratively, the premium is a one-time payment, but a time series of payments may also be used.

In Step 20, a Reinsurer R acquires part of the risk which has been transferred to the Insurer Z. Illustratively, the Reinsurer R is a captive of the insured Corporation X, although this is not necessarily the case. Generally, a captive insurer is an insurance company that is organized and controlled by the company's policyholders. Further, in the transaction between Insurer Z and Reinsurer R, a retainment point, an initial attachment point, and the investment growth rate for the attachment point are determined. These “points” and “growth” will be described in detail below.

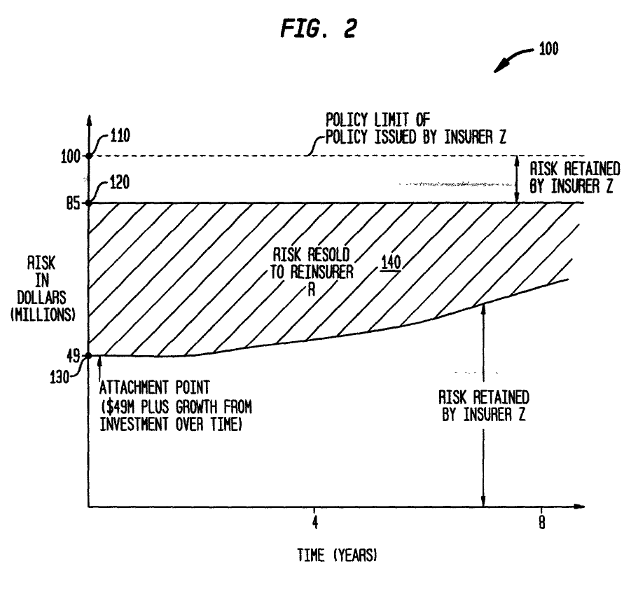

In particular, in exchange for a premium (e.g. $0.65 million in the current example), a significant fraction of the $100 million risk of Insurer Z is transferred to Reinsurer R. The risk or limit of liability that is transferred to Reinsurer R is the difference between a variable attachment point and a fixed retainment point, as is explained below in connection with graph 100 of FIG. 2.

As shown at point 110 in FIG. 2, the initial risk to Insurer Z is $100 million. Insurer Z determines a fixed amount of risk that it will retain (i.e., the retainment point 120) if a payout, due to an occurrence of one of the insured specified events, is greater than such retainment point. In this example, we will assume that retainment point 120 is $85 million. Therefore, Insurer Z retains $15 million of the total $100 million risk (the difference between $100 million and $85 million). The Insurer Z cedes to Reinsurer R the difference between $85 million and the variable attachment point. We will assume that the attachment point 130 is set initially at $49 million. The attachment point is determined by Insurer Z or negotiated between Insurer Z and Reinsurer R, based on several factors, such as the amount of risk, the premium paid by the insured, the type of insured events, and a projected loss probability. The initial attachment point is usually an amount different from the premium received from the insured. In addition, as shown in FIG. 2, the attachment point increases over time. This is due to an investment growth that is determined negotiated between Insurer Z and Reinsurer R. The investment growth may be a fixed or variable rate based on, e.g., 1 or 2 year treasury rates, the LIBOR rate, etc. Accordingly, the risk transferred to Reinsurer R, which is represented by the shaded area 140 in FIG. 2, decreases over time. As shown, the remainder of the original $100 million risk (i.e. area below the attachment point in FIG. 2) remains with Insurer Z. Note that the retainment point and the variable attachment points may be determined via the computer system 200, as shown in FIG. 3.

For example, let us assume that the insured Corporation X has a $95 million occurrence in year 4 of the insurance policy. As shown in FIG. 2, the variable attachment point is at $53 million in year 4. Therefore, Reinsurer R pays $32 million to Insurer Z ($85 million (the retainment point) less $53 million (the variable attachment point)) at Step 60 of FIG. 1, and Insurer Z pays the $95 million (using its own $63 million) to Corporation X at Step 70. Now, let us assume that the insured Corporation X has a $75 million occurrence in year 4 of the insurance policy. Again, the variable attachment point is at $53 million, and Reinsurer R pays $22 million to Insurer Z ($75 million (since it is lower than the retainment point) less $53 million (the variable attachment point)) at Step 60 and Insurer Z pays the $75 million (using its own $53 million) to Corporation X at Step 70.

Returning further to FIG. 1, the Reinsurer R optionally transfers its full insurance obligation to a third party Reinsurer P in exchange for a premium, in Step 30. For example, the premium is illustratively $0.5 million. Accordingly, let us assume that the insured Corporation X has the $95 million occurrence in year 4 of the insurance policy. Now, Reinsurer P pays $32 million to Reinsurer R at Step 50, Reinsurer R pays the $32 million (using none of its own money) to Insurer Z at Step 60, and Insurer Z pays Corporation X the $95 million (using its own $63 million) at Step 70.

Reinsurer P is illustratively a pool administrator and serves to pool risks from, e.g., a plurality of like-sized companies with similar technology specific exposures. Thus, as shown in FIG. 1, in addition to the Corporation X participating in the pool, Companies A and B may also participate in the pool. Further, at Step 40, Reinsurers A and B transfer their full insurance obligation to third party Reinsurer P in exchange for a predetermined premium.

As stated, Reinsurer P may act as a pool administrator and the Corporations X, A, and B may act as pool members. Generally, in such an insurance pool all pool members are made aware of the nature of all risks placed into the pool. Further, in general, the third party reinsured P facilitates the process of identifying appropriate risks and acts as a pool administrator, and the pool members retain the right to influence what types of companies and risks join the pool.

As an example, Reinsurer P sponsors a Technology Risk Pool and acts as the pool administrator. The pool administrator typically sets the amount of the premiums for each participant in the pool. Further, the pool administrator, along with the pool participants (X, A, B) agree on the coverage.

An insurance pool, as described above, may be formed by a “pooling agreement.”Such pooling agreement illustratively may include terms such as the pool administrator, pool members, the effective date, the termination date, the coverage, the premium, the participant limits, the participant ratios, a risk sharing provision, and a lost reimbursement and claims handling provision. For example, the “Pool Administrator” provision may state, “P reinsurer.” The “Pool Participants” provision may state, “Computer, technology and Internet focused companies meeting the criteria in Exhibit A. New Pool Participants meeting “certain criteria” will be added only with the written consent of all existing Pool Participants and the Pool Administrator.”

Such “certain criteria” may include requirements that the Companies must derive more than 80% of their operating revenues from Computer, technology and/or Internet businesses, that the Companies must have a market capitalization of at least $1.5 billion on the date they enter the Pool, that the Companies must have an S&P credit rating of at least A− on the date they enter the Pool, that credit downgrades below A− will require the posting of collateral equal to the individual Company's limit, that the Companies may submit to the Pool only those risks that are relevant to the computer, technology and/or Internet industry and that are acceptable to both the Pool Administrator and existing Pool Participants, that the Companies must be willing to maintain a per occurrence retention of at least $2.5 million on all claims, that the Companies must provide an initial program Self Insured Retention (“SIR”) of a minimum of $30 million (the SIR may increase over the term of the Pool but not decrease), and that the Companies can cede to the Pool a Participant Limit (defined as the Specific Limit less the SIR) of at least $20 million and no great than 125% of the dollar value of the SIR on the date the Participant joined the Pool.

Regarding the “Effective Date”, this provision may state, “Date/Month/Year, or the date of the premium payment by the first Pool Participant, whichever is later. This indication is valid until 5:00 p.m. EST Date/Month/Year.” The “Termination Date” provision may state, “The tenth anniversary of the Effective Date. This program is non-cancelable by the Pool Participants or by the Pool Administrator.” The “Coverage” provision may state, “To be agreed upon by Pool Administrator and Pool Participants.” The “Premium” provision may state, “An amount established by the Pool Administrator relating to the nature of the coverage provided payable on or before the Effective Date. The premium is exclusive of any excise or premium taxes. The premium will be aggregated with the premium from other Pool Participants and used primarily for loss adjustment expenses and claims administration. Any unused premiums at the end of the ten-year policy term will be returned to the Pool Participants based on the Participant Ratios.” The “Participant Limit” provision may state, “The Participant Limit will be defined as each Pool Participant's Specific Limit in excess of a Self-Insured Retention (“SIR”).” The “Participant Ratio” provision may state, “the Participant Ratio equals (a) the Participant Limit for an individual Pool Participant divided by (b) the sum of the Participant Limits for all Pool Participants.” The “Risk Sharing” provision may state, “In the event of a claim, Pool Participants must remit within 30 days their share of the following risk sharing formula: The Pool Participant making the claim will owe (a) one half the total amount of the claim plus (b) its Participant Ratio times half the total amount of the claim. The remaining Pool Participants will each owe their respective Participant Ratio times half the total amount of the claim.” Lastly, the “Loss Reimbursement and Claims Handling” provision may include “claims control and cooperation” and “settlement of losses” clauses, such as “Losses are to be settled annually within 60 days of each anniversary of the Effective Date. All claims will be presented to the Pool Administrator. The Pool Administrator will be responsible for verifying and validity of all claims or assigning the responsibility to a claims administrator agreed to by the Pool Participants.”

In the above insurance pool scenario of FIG. 1, the following is an example of a policy between Reinsurer R and Reinsurer P (Step 30). Such policy may illustratively include terms such as the coverage, the premium, the participant limit, the specific limit, and the interest rate and term provisions.

For example, the “Coverage” provision may state, “Claims made coverage for occurrences reported subsequent to the Effective Date and prior to the Termination Date noted above for losses and loss adjustment expenses, including defense costs, related to claims against X for technology specific risks. Such claims must relate to actual settlements is negotiated or court ordered.” The “Premium” provision may state, “$500,000, representing X% of worldwide sales on covered products.” The “Participant Limit” provision may state, “The Participant Limit will be the portion of the Specific Limit in excess of an initial Self-Insured Retention (“SIR”) of $49,000,000 for Covered losses in excess of a retention of $2,000,000 for any one claim and in the annual aggregate. The SIR increases annually as follows: SIR at the beginning of the year ($49,000,000 at inception); Plus—Annual interest at a rate shown below; Less—Losses paid under the program during the year; and Equals—SIR at the end of the year.” The “Specific Limit” provision may state, “The Specific Limit will be defined as $85,000,000. In the event that no claims are presented during the first four years of the program, P Reinsurer will also assume the Specific Limit between $85,000,000 and $100,000,000.” Lastly, the “Interest Rate and Term” provision may state, “The SIR will increase as shown above using an interest rate equal [To Be Determined], reset at each anniversary of the Effective Date.”

As indicated above, a computer system, such as personal computer 200 in FIG. 3, may be implemented to compute the projected loss probability (i.e., the occurrence probability of any of the insured events), the premium, the retainment point, and the initial attachment point, and the amount of investment growth for the attachment point.

Computer system 200 illustratively includes a processor 210, such as a Pentium chip, a memory 220, such as an internal hard drive, a display 230, such as a CRT, flat-screen, or printer, an input device 240, such as a keyboard or mouse, and a secondary storage 250, such as a CD ROM or a disk drive. Of course, computer system 200 is merely an example and any iteration of computer system 200 or any other processing device may be used.

Generally, internal hard drive 220 stores a software program(s) to compute the projected loss probability, the premium, the retainment point, and the initial and variable attachment points. Such software programs may be written in any desired programming language, such as C++ or Java. In addition, the software program may be located at a remote server of a local network, across the Internet, or over a dedicated line (not shown). Further, the programs may be implemented in hardware or firmware (not shown). To compute the above, data may be input into computer system 200 via, e.g., an input device 240 or via a network or Internet connection (not shown). Such data may include the types of insured events, the risk limit, and various statistical and actuary data.

Finally, the above-described embodiments of the invention are intended to be illustrative only. Numerous alternative embodiments may be devised by those having ordinary skill in the art without departing from the spirit and scope of the invention.

What is claimed is:

1. A method for providing financial assurance, against an occurrence of at least one specified event, via an insurance policy, the method comprising the steps of:
a) providing, by an insurer, an insurance policy having a risk limit, in exchange for a predetermined first premium from the insured entity, wherein said risk limit is the maximum monetary risk; and
b) transferring, from said insurer to a first reinsurer, a variable portion of said risk limit, in exchange for a predetermined second premium,
wherein said variable portion decreases over time, and wherein said variable portion is a predetermined retainment point less a variable attachment point, such that said retainment point is a monetary amount less than said risk limit, and said variable attachment point varies over time based on a predetermined investment growth.

2. The method of claim 1, further comprising the step of:
c) transferring, from said first reinsurer to a second reinsurer, said variable portion of said risk limit, in exchange for a predetermined third premium.

3. The method of claim 2, wherein said first reinsurer is a captive insurer of said insured entity, and wherein said second reinsurer is a third party reinsurer.

4. The method of claim 3, further comprising the step of:
d) transferring, from at least one third reinsurer to said second reinsurer, a portion of a respective risk limit from each insurance policy of a respective insured entity, in exchange for each predetermined respective fourth premium, and
wherein said second reinsurer pools each received portion of said risk limit, from said first reinsurer and each of said at least one third reinsurer, to provide risk sharing.

5. The method of claim 4, wherein each of said insured entities is a pool participant of said second reinsurer, and wherein said second reinsurer is a pool administrator.

6. The method of claim 5, wherein said pool administrator determines said predetermined third premium and each said predetermined respective fourth premium.

7. The method of claim 6, wherein each of said at least one third reinsurer is a captive insurer of said respective insured entity.

8. The method of claim 7, wherein each said insured entity derives at least a predetermined revenue from a same industry class.

9. The method of claim 8, wherein said same industry class includes at least one of computer, technology, and Internet businesses.

10. The method of claim 2, wherein said insurer retains a risk amount equal to said risk limit less said variable portion, wherein said risk amount varies over time based on said variable attachment point.

11. The method of claim 10, wherein said variable attachment point is at least initially less than said first premium.

12. The method of claim 1, wherein said insurance policy is non-cancelable by either said insurer or said insured entity.

13. The method of claim 1, wherein said maximum monetary risk is apportioned into maximum yearly risk and maximum occurrence risk, such that there is a maximum monetary limit payable to said insured entity per year and per occurrence.

14. The method of claim 1, further comprising the steps of:
(c) notifying, by said insured entity to said insurer, of an occurrence and an occurrence amount of an insured specified event;
(d) paying, from said insurer to said insured entity, said occurrence amount up to said risk limit;
(e) paying, from said first reinsurer to said insurer, an amount equal to said occurrence amount less said variable attachment point if said occurrence amount is equal to or less than said retainment point; and
(f) paying, from said first reinsurer to said insurer, an amount equal to said retainment point less said variable attachment point if said occurrence amount is greater than said retainment point.

15. The method of claim 2, further comprising the steps of:
(d) notifying, by said insured entity to said insurer, of an occurrence and an occurrence amount of an insured specified event;
(e) paying, from said insurer to said insured entity, said occurrence amount up to said risk limit;
(f) paying, from said second reinsurer to said first reinsurer, an amount equal to said occurrence amount less said variable attachment point if said occurrence amount is equal to or less than said retainment point;
(g) paying, from said second reinsurer to said first reinsurer, an amount equal to said retainment point less said variable attachment point if said occurrence amount is greater than said retainment point;
(h) paying, from said first reinsurer to said insurer, an amount equal to said occurrence amount less said variable attachment point if said occurrence amount is equal to or less than said retainment point; and
(i) paying, from said first reinsurer to said insurer, an amount equal to said retainment point less said variable attachment point if said occurrence amount is greater than said retainment point.

16. An insurance policy for providing financial assurance, against an occurrence of at least one specified event, to an insured entity, comprising:
a risk limit in exchange for a predetermined first premium from the insured entity, wherein said risk limit is the maximum monetary risk,
wherein a variable portion of said risk limit from said insurance policy is transferred from said insurer to a first reinsurer, in exchange for a predetermined second premium,
wherein said variable portion decreases over time, and wherein said variable portion is a predetermined retainment point less a variable attachment point, such that said retainment point is a monetary amount less than said risk limit, and said variable attachment point varies over time based on a predetermined investment growth.

17. The insurance policy of claim 16, wherein said variable portion of said risk limit is transferred from said first reinsurer to a second reinsurer, in exchange for a predetermined third premium.

18. The insurance policy of claim 17, wherein said first reinsurer is a captive insurer of said insured entity, and wherein said second reinsurer is a third party reinsurer.

19. The insurance policy of claim 18, wherein a portion of a respective risk limit from each insurance policy of a respective insured entity is transferred from at least one third reinsurer to said second reinsurer, in exchange for each predetermined respective fourth premium, and
wherein said second reinsurer pools each received portion of said risk limit, from said first reinsurer and each of said at least one third reinsurer, to provide risk sharing.

20. The insurance policy of claim 19, wherein each of said insured entities is a pool participant of said second reinsurer, and wherein said second reinsurer is a pool administrator.

21. The insurance policy of claim 20, wherein said pool administrator determines said predetermined third premium and each said predetermined respective fourth premium.

22. The insurance policy of claim 21, wherein each of said at least one third reinsurer is a captive insurer of said respective insured entity.

23. The insurance policy of claim 22, wherein each said insured entity derives at least a predetermined revenue from a same industry class.

24. The insurance policy of claim 23, wherein said same industry class includes at least one of computer, technology, and Internet businesses.

25. The insurance policy of claim 17, wherein said insurer retains a risk amount equal to said risk limit less said variable portion, wherein said risk amount varies over time based on said variable attachment point.

26. The insurance policy of claim 25, wherein said variable attachment point is at least initially less than said first premium.

27. The insurance policy of claim 16, wherein said insurance policy is non-cancelable by either said insurer or said insured entity.

28. The insurance policy of claim 16, wherein said maximum monetary risk is apportioned into maximum yearly risk and maximum occurrence risk, such that there is a maximum monetary limit payable to said insured entity per year and per occurrence.

29. The insurance policy of claim 16, wherein said insurance policy further comprises notice terms regarding notifying, by said insured entity to said insurer, of an occurrence and an occurrence amount of an insured specified event, wherein upon such notification of said occurrence and said occurrence amount, said insurer pays to said insured entity said occurrence amount up to said risk limit,
wherein an amount equal to said occurrence amount less said variable attachment point is paid from said first reinsurer to said insurer, if said occurrence amount is equal to or less than said retainment point, and
wherein an amount equal to said retainment point less said variable attachment point is paid from said first reinsurer to said insurer, if said occurrence amount is greater than said retainment point.

30. The insurance policy of claim 17, wherein said insurance policy further comprises notice terms regarding notifying, by said insured entity to said insurer, of an occurrence and an occurrence amount of an insured specified event, wherein upon such notification of said occurrence and said occurrence amount, said insurer pays to said insured entity said occurrence amount up to said risk limit,
wherein an amount equal to said occurrence amount less said variable attachment point is paid from said second reinsurer to said first reinsurer, if said occurrence amount is equal to or less than said retainment point,
wherein an amount equal to said retainment point less said variable attachment point is paid from said second reinsurer to first reinsurer, if said occurrence amount is greater than said retainment point,
wherein an amount equal to said occurrence amount less said variable attachment point is paid from said first reinsurer to said insurer, if said occurrence amount is equal to or less than said retainment point,
wherein an amount equal to said retainment point less said variable attachment point is paid from said first reinsurer to insurer, if said occurrence amount is greater than said retainment point.

31. A data processing system for processing an insurance policy having a risk limit for providing financial assurance, against an occurrence of at least one specified event, to an insured entity, wherein said risk limit is the maximum monetary risk, said data processing system comprising:
a processor for determining a projected loss amount probability, and for determining a first premium, a retainment point, and a variable attachment point based on at least said risk limit and said projected loss amount probability,
wherein said processor further determines an investment growth of said variable attachment point,
wherein a variable portion of said risk limit from said insurance policy is transferred from said insurer to a first reinsurer, in exchange for a predetermined second premium,
wherein said variable portion decreases over time, and wherein said variable portion is based on said retainment point less said variable attachment point, such that said retainment point is a monetary amount less than said risk limit, and said variable attachment point varies over time based on the determined investment growth.
